(19) United States
(12) Patent Application Publication
(10) Pub. No.: US 2021/0136880 A1
(43) Pub. Date: May 6, 2021

(54) INDUCTION HEATING COOKER

(71) Applicant: LG ELECTRONICS INC., Seoul (KR)

(72) Inventors: Dooyong OH, Seoul (KR); Byeong Wook PARK, Seoul (KR); Seungbok OK, Seoul (KR)

(21) Appl. No.: 16/488,731

(22) PCT Filed: Feb. 23, 2018
(86) PCT No.: PCT/KR2018/002282

§ 371 Date: Aug. 26, 2019

(30) Foreign Application Priority Data
Feb. 24, 2017 (KR) 10-2017-0024632
Dec. 15, 2017 (KR) 10-2017-0173671

(51) Int. Cl. H05B 6/12; H05B 6/06

(52) U.S. Cl. CPC H05B 6/1281; H05B 2206/022; H05B 6/065

(57) ABSTRACT

The present invention relates to an induction heating cooker and, more specifically, to an induction heating cooker comprising triple heating coils which have the same center and operate by different power sources. The induction heating cooker of the present invention comprises a control unit for controlling first to third coil driving circuits so as to operate the first to third heating coils at the same frequency.

### TECHNICAL FIELD

The present invention relates to an induction heating cooker, and more particularly, to an induction cooking heater including a triple heating coil which has the same center and operates using different power sources.

### BACKGROUND ART

Generally, induction heating cookers are electrical cooking apparatuses which perform a cooking function using a method of heating a cooking container by applying a high-frequency current to a working coil or a heating coil such that an eddy current flows while a line of intensive magnetic force generated thereby passes through the container.

In consideration of a basic heating principle of such induction heating cookers, as a current is applied to a heating coil, a cooking container formed of a magnetic material generates heat by induction heating such that the cooking container is heated by the generated heat to perform cooking.

Here, referring to U.S. Patent Publication No. 2005/0109770 A1, an induction heating cooker using a conventional multiple coil structure is disclosed. With reference to this, a conventional induction heating apparatus will be described.

FIG. 1 is a view of a conventional induction heating cooker. For reference, FIG. 1 is a drawing attached to U.S. Patent Publication (US 2005/0109770A1).

Referring to FIG. 1, the conventional induction heating cooker includes first and second power modules 1 and 3 capable of supplying power to a first heating coil 5 and a second heating coil 9, respectively.

Also, a heating area of a cooking container 21 such as a pot includes first and second heating areas 13 and 15. Here, the first heating coil 5 disposed in the first heating area 13 is controlled by the first power module 1, and the second heating coil 9 disposed in the second heating area 15 is controlled by the second power module 3.

The first and second power modules 1 and 3 supply maximum power to the first and second heating coils 5 and 9 at the same time, respectively, such that the cooking container 21 may be quickly heated. That is, the first and second power modules 1 and 3 supply maximum power to the first and second heating coils 5 and 9, respectively, so as to increase an entirety of output power provided to the cooking container 12.

However, when the two heating coils are provided in the heating area for one cooking container like the conventional induction heating cooker, in order to increase output power using the two heating coils, it is necessary to drive a plurality of such power modules at the same time by inputting power having the same phase. In this case, since it is necessary that each of the heating coils receives power having the same phase, it is difficult to provide high power in three-phase environments as in Europe.

Also, one heating coil can not output power greater than or equal to 3.7 kW in a power environment in which a phase current is restricted. Accordingly, a structural limitation, in which maximum power is limited to 7.2 kW, is present in the case of a dual heating coil using two heating coils.

### DISCLOSURE

### Technical Problem

The present invention is directed to providing an induction heating cooker which provides a maximum output greater than or equal to 10 kW. The induction heating cooker includes a triple heating coil formed of three coils having the same center and disposed to be spaced apart from each other, and the coils are operated by different types of power having three phases or a single phase such that maximum output is increased.

The present invention is also directed to providing an induction heating cooker including a triple heating coil formed of three coils receiving different types of power having three phases or a single phase to increase maximum output.

The present invention is also directed to providing an induction heating cooker including a triple heating coil formed of three coils in which a size of a container on heating coils is sensed and only coils located below the container are operable according to the size of the container such that only heating coils located below the container are operated automatically.

Aspects of the present invention are not limited to the above-stated aspects and other unstated aspects of the present invention will be understood by a following description and more definitely understood through embodiments of the present invention. Also, it may be easily seen that the objects and advantages of the present invention can be embodied by components and combinations thereof stated in the claims.

### Technical Solution

One aspect of the present invention provides an induction heating cooker including first to third heating coils operated by different types of power, first to third coil driving circuits, which control the first to third heating coils, respectively, and a control portion which controls the first to third coil driving circuits to operate the first to third heating coils with the same frequency.

Another aspect of the present invention provides an induction heating cooker including first to third heating coils operated by first to third alternating current (AC) power source portions, which are different from each other, and first to third coil driving circuits controlling the first to third heating coils, respectively. Here, the first to third AC power source portions have different phases or the same phase.

Still another aspect of the present invention provides an induction heating cooker including first to third heating coils operated by first to third AC power source portions, which are different from each other, first to third coil driving circuits controlling the first to third heating coils, respectively, a control portion controlling operations of the first to third heating coils, and a sensing portion measuring a size of a container disposed on the first to third coil driving circuits. Here, the control portion determines whether to operate the first to third coil driving circuits using data obtained through measuring by the sensing portion.

### ADVANTAGEOUS EFFECTS

According to the present invention, in the induction heating cooker, a triple heating coil including three coils, which have the same center and are spaced apart from each other, is used such that maximum power of the induction heating cooker may be increased to 10 kW. Through this, since maximum power is available in general home environments, a time necessary for cooking may be reduced and needs of customers who want greater firepower may be satisfied.

Also, in the induction heating cooker according to the present invention, the triple heating coil formed of three coils receiving different types of power having three phases or a single phase is used. Through this, the induction heating cooker of the present invention is operable in all power source environments which are different for each country such that versatility of products is increased. Also, each coil included in the induction heating cooker operates with the same operation frequency such that noise occurring when a plurality of coils operate with different frequencies may be eliminated and an output deviation of the plurality of coils caused by a phase deviation may be improved. Through this, quietness of the induction heating cooker may be improved and stability of output and operation of the induction heating cooker may be improved.

Also, in the induction heating cooker according to the present invention, a size of a container on heating coils may be sensed and only coils located below the container may be operated according to the size of the container. Through this, unnecessary coils may not be operated so as to maximize energy efficiency, and only necessary heating coils may be operated automatically without an additional manipulation of a user to improve user convenience.

### DESCRIPTION OF DRAWINGS

FIG. 1 is a view of a conventional induction heating cooker.

FIG. 2 is a perspective view of an induction heating cooker according to some embodiments of the present invention.

FIG. 3 is a view illustrating a principle of heating a cooking container by the induction heating cooker of FIG. 2.

FIG. 4 is a block diagram of an induction heating cooker according to some embodiments of the present invention.

FIG. 5 is a block diagram of an induction heating cooker according to one embodiment of the present invention.

FIG. 6 is a block diagram of an induction heating cooker according to another embodiment of the present invention.

FIG. 7 is a block diagram of an induction heating cooker according to still another embodiment of the present invention.

FIG. 8 is a view illustrating a triple heating coil included in the induction heating cooker according to some embodiments of the present invention.

FIG. 9 is a cross-sectional view taken along line X-X of FIG. 8.

FIG. 10 is a cross-sectional view illustrating a triple heating coil included in an induction heating cooker according to other embodiments of the present invention.

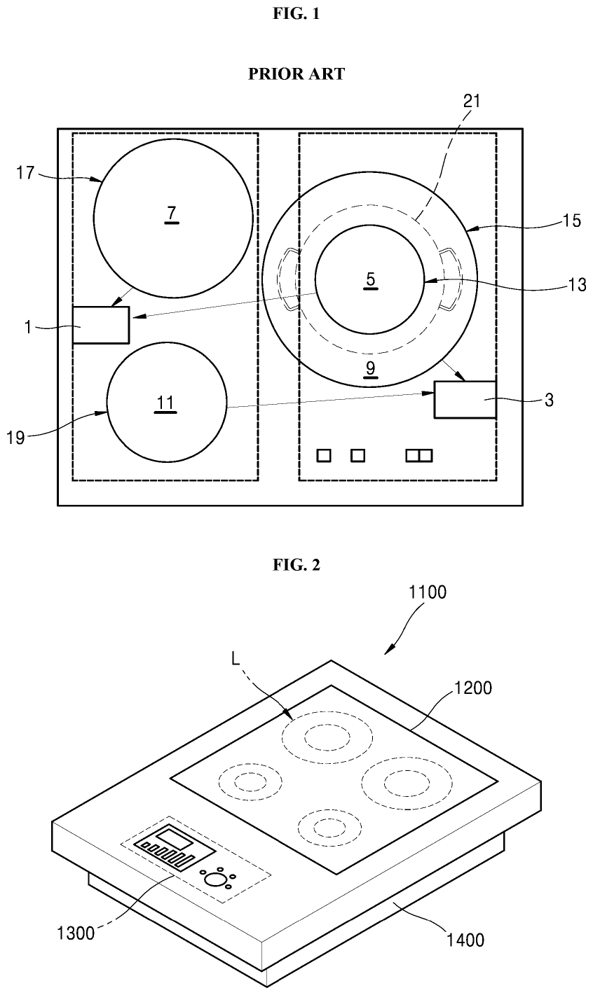

### MODES OF THE INVENTION

The terms used in the specification and the claims should not be limited to general or lexical meanings and should be interpreted as meanings and concepts coinciding with the technical concept of the present invention on the basis of a principle in which the inventor can appropriately define the concept of the terms to describe the invention in the best manner. Also, since embodiments disclosed in the specification and components shown in the drawings are merely exemplary embodiments of the present invention and do not represent an entirety of the technical concept of the present invention, it should be understood that a variety of equivalents and modifications capable of substituting for the embodiments and the components may be present at the time of filing of the presents application.

Hereinafter, an induction heating cooker according to embodiments of the present invention will be described in detail with reference to the drawings.

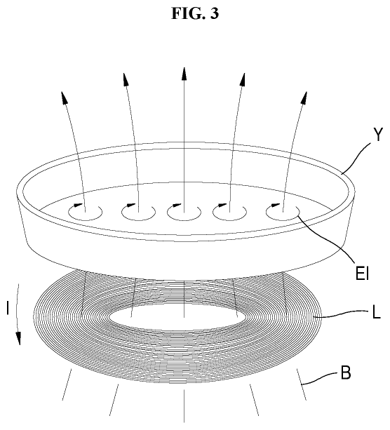

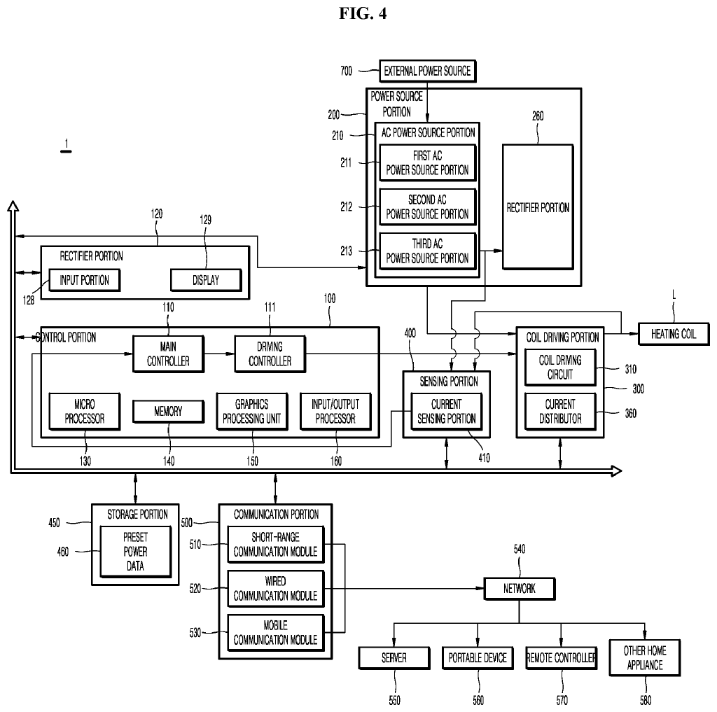

FIG. 2 is a perspective view of an induction heating cooker according to some embodiments of the present invention. FIG. 3 is a view illustrating a principle of heating a cooking container by the induction heating cooker of FIG. 2. FIG. 4 is a block diagram of an induction heating cooker according to some embodiments of the present invention.

Referring to FIG. 2, the induction heating cooker according to some embodiments of the present invention includes a body housing 1100, a cooking plate 1200, a user interface portion 1300, and a driving circuit 1400.

The cooking plate 1200 on which a container is placed may be disposed on the body housing 1100. The user interface portion 1300, which receives user's input and displays state information of the induction heating cooker, may be disposed on one side of a top surface of the body housing 1100, and the driving circuit 1400 of the induction heating cooker may be located below the body housing 1100. However, the present invention is not limited thereto.

A plurality of heating coils L installed below the cooking plate 1200 to provide the cooking plate 1200 with a heating source are provided in the body housing 1100. The heating coils L may be disposed below an entire surface of the cooking plate 1200.

The heating coils L may be separated into a plurality of coils. For example, the heating coils L may include a triple heating coil, a dual heating coil, and a single heating coil. The heating coils L may use the plurality of coils, and the plurality of coils may receive power from different sources and implement high power. Hereinafter, the heating coils L including the triple heating coil and capable of implementing highest power will be described below in detail.

The cooking plate 1200 may be formed of tempered glass such as ceramic glass so as to not be easily broken. Also, a guide mark may be formed on the cooking plate 1200 to indicate to a user a position of a cooking container Y as shown in FIG. 2.

The driving circuit 1400 for driving the heating coils L may be disposed below the cooking plate 1200. The driving circuit 1400 will be described below in detail.

The user interface portion 1300 for controlling the heating coils L may be disposed on one side of a top of the body housing 1100. The user interface portion 1300 may include an operation portion including a plurality of operation buttons receiving a command of the user and a display portion which displays information related to an operation state of the induction heating cooker. However, the user interface portion 1300 shown in FIG. 2 is merely one embodiment of the present invention, and the present invention is not limited thereto and may be used while being modified into a variety of embodiments.

The user may dispose a container on the cooking plate 1200 and set a power level of the heating coils L located below the container by pushing the operation button included in the user interface portion 1300 so as to supply high-frequency power corresponding to the power level to the heating coils L.

Among methods of heating a container using the heating coils L of the present invention, there are a method of conducting heat to a cooking container by generating heat in the heating coils and a method of induction-heating a magnetic cooking container using a magnetic field generated by applying currents to the heating coils.

Hereinafter, the method of induction-heating the cooking container using the magnetic field will be described with reference to FIG. 3.

Referring to FIG. 3, when currents (I) are supplied to the heating coils L, a magnetic field B passing through an inside of the heating coils L is induced. Particularly, when a current, which changes over time, that is, an alternating current, (AC) is supplied to the heating coils L, the magnetic field B, which changes over time, is induced inside the heating coils L. The magnetic field B generated by the heating coils as described above passes through a bottom surface of the cooking container Y.

When the magnetic field B, which changes over time, passes through a conductor, a current rotating around the magnetic field B occurs. A phenomenon in which a current is induced by the magnetic field B, which changes over time, as described above is referred to as an electromagnetic induction phenomenon, and the rotating current is referred to as an eddy current. In the case of a cooking container using induction heating, the electromagnetic induction phenomenon and the eddy current are generated on the bottom surface of the cooking container Y.

In detail, the magnetic field B generated by the heating coils L passes through the bottom surface of the cooking container Y, an eddy current EI, which rotates around the magnetic field B, is generated inside the bottom surface of the cooking container Y. The cooking container Y is heated by the eddy current EI. In detail, when the eddy current EI flows through the cooking container Y having electrical resistance, atomic nuclei forming the cooking container Y collide with electrons caused by the eddy current EI. Heat is generated by the collision between atomic nuclei and electrons.

That is, the induction heating cooker may supply currents to the heating coils L and may heat the cooking container Y using the magnetic field B generated by the heating coils L.

Referring to FIG. 4, an induction heating cooker according to some embodiments of the present invention may include heating coils L, a power source portion 200, a coil driving portion 300, a sensing portion 400, a control portion 100, a storage portion 450, a communication portion 500, and a user interface 120.

The heating coils L generate a magnetic field such that an eddy current flows through the cooking container Y.

The power source portion 200 receives power from the outside and converts the power into direct current (DC) type power.

The power source portion 200 may receive single-phase or three-phase power from an external AC power source 700. The power source portion 200 may include an AC power source portion 210 and a rectifier portion 260.

The AC power source portion 210 may receive AC power from the external AC power source 700 and convert the AC power into three-phase AC power. In this case, the AC power source portion 210 may include a first AC power source portion 211 which generates R-phase AC power, a second AC power source portion 212 which generates S-phase AC power, and a third AC power source portion 213 which generates T-phase AC power. Also, the first AC power source portion 211 to the third AC power source portion 213 can not use power at a particular level or higher. For example, in one phase, a maximal current of 16 A and power of 3.6 kW may be generated. Accordingly, the induction heating cooker may generate power of about 10.8 kW.

The rectifier portion 260 may generate DC power by rectifying the three-phase AC power generated by the AC power source portion 210. Also, the rectifier portion 260 may uniformly maintain the generated DC power by reducing a change thereof. That is, the rectifier portion 260 may include a rectifier circuit RC, which converts AC power into DC power, and a smoothing circuit SC which uniformly maintains the DC power. For example, the rectifier circuit RC may have a form in which four full-bridge-shaped diodes are disposed, and the smoothing circuit SC may have a shape in which capacitors are connected to two stages thereof in parallel.

However, the power source portion 200 shown in FIG. 4 is merely an example, and the present invention is not limited thereto. For example, in some embodiments, the power source portion 200 may be used without the rectifier portion 260.

The coil driving portion 300 converts flowing-in AC or DC power into high-frequency power to supply the high-frequency power to the heating coils L and distributes currents, which flow through the plurality of heating coils, to adjust power to be consumed by the heating coils. The coil driving portion 300 may include a coil driving circuit 310 and a current distributor 360.

The coil driving circuit 310 may include first to third coil driving circuits 311, 312, and 313 which control three separate heating coils included in the triple heating coil. A detailed description thereof will be present below.

The sensing portion (or sensor) 400 senses and transmits an operation of the induction heating cooker to the control portion 100. In detail, the sensing portion 400 may include a current sensing portion 410 which senses an input current supplied from the AC power source portion 210 to the rectifier portion 260 and a driving current supplied from the coil driving portion 300 to the heating coils L. Also, the sensing portion 400 may measure and transmit a size of a container disposed on the heating coils L to the control portion 100.

The control portion 100 may integrally control operations of the induction heating cooker.

The control portion 100 may include a main controller 110, which controls operations of the induction heating cooker on the basis of power of each of the heating coils sensed by the sensing portion 400, a user command from the user interface 120, preset power data in the storage portion 450, and the like, and a driving controller 111 which controls the coil driving portion 300 and a switching portion 800 corresponding to a control command of the main controller 110.

The control portion 100 may transmit a control signal to a component which performs each operation to perform the operations of the induction heating cooker according to the input user command. Also, the control portion 100 controls overall operations and a signal flow of internal components of the induction heating cooker and processes data. Also, the control portion 100 controls such that power supplied by the power source portion 200 is transmitted to internal components of the induction heating cooker. Also, the control portion 100 may prioritize a plurality of heating coils on the basis of a plurality of driving currents sensed by the current sensing portion 410 and may distribute currents so as to distribute power to be supplied to the heating coils.

In detail, the control portion 100 transmits a control signal corresponding to an output level input into the user interface 120 to the coil driving portion 300 so as to adjust a level and a frequency of high-frequency power generated by a coil driving circuit of the coil driving portion 300.

For example, the control portion 100 may supply driving power to heating coils included in a burner required to operate by selectively cutting off supplying of driving power from the coil driving circuit to the heating coils and may cut off supplying of driving power to heating coils included in a burner not required to operate. Also, the control portion 100 may determine a load of each power source portion by comparing power consumed by each of the heating coils sensed by the sensing portion 400. Also, the control portion 100 may supply power to the burner required to operate by adjusting the switching portion 800 or the coil driving circuit on the basis of the determined load of each power source portion.

The control portion 100 may be implemented as a central processing unit (CPU), and the CPU may be implemented as, for example, a microprocessor 130. Here, the microprocessor 130 is a processing unit in which an arithmetic and logic unit (ALU), a register, a program counter, a command decoder, a control circuit, or the like is provided on at least one silicon chip. The microprocessor 130 may be implemented as a system on chip (SoC) which includes a core and a graphics processing unit (GPU). The microprocessor 130 may include a single core, a dual core, a triple core, a quad core, and a multiple core.

Also, the control portion 100 may include a GPU 150 for processing graphics of an image or video.

Also, the control portion 100 may include an input/output processor 160, which mediates input and output of data between a variety of components included in the induction heating cooker and the control portion 100, and a memory 140 which temporarily or nontemporarily stores programs and data. The memory 140 may be implemented as a random-access memory (RAM) or a read-only memory (ROM).

The storage portion 450 may store data and programs necessary for controlling of the induction heating cooker. For example, the storage portion 450 may store preset power data 460 for adjusting driving power supplied to the heating coils. Here, the preset power data 460 is data for determining a driving current to be distributed to each of the heating coils on the basis of the driving current supplied to each of the heating coils sensed by the current sensing portion 410 and for determining a switching operation for receiving power of a different phase when an output level input according to a user command input into the user interface 120 exceeds maximum power.

The storage portion 450 may include a nonvolatile memory such as a ROM, a high-speed RAM, a magnetic disk storage device, and a flash memory or another nonvolatile semiconductor memory device.

For example, the storage portion 450 is a semiconductor memory device, and a secure digital (SD) memory card, a secure digital high capacity (SDHC) memory card, a mini SD memory card, a mini SDHC memory card, a trans flash (TF) memory card, a micro SD memory card, a micro SDHC memory card, a memory stick, a compact flash (CF) memory card, a multi-media card (MMC), an MMC micro, an extreme digital (XD) card, and the like may be used.

Also, the storage portion 450 may include a network-attached storage device accessed through a network.

The communication portion 500 may be connected to a network 540 through wires or wirelessly and communicate with another home appliance 580 or a server 550 thereoutside. The communication portion 500 may transmit and receive data to and from the server 550 or the other home appliance 580 connected through a home server 550. Also, the communication portion 500 may communicate data according to standards of the home server.

The communication portion 500 may transmit and receive data related to remote control through the network 540 and may transmit and receive information related to an operation of the other home appliance 580. In addition, the communication portion 500 may receive information related to a life pattern of the user from the server 550 and utilize the information for the operation of the induction heating cooker. Also, the communication portion 500 may perform data communication with not only the server 550 or a remote controller 570 in the home but also a portable terminal 560 of the user.

The communication portion 500 may be connected to the network 540 through wires or wirelessly and transmit and receive data with the server 550, the remote controller 570, the portable terminal 560, or the other home appliance 580. The communication portion 500 may include one or more components which communicate with the other home appliance 580. For example, the communication portion 500 may include a short-range communication module 510, a wired communication module 520, and a mobile communication module 530.

The short-range communication module 510 may be a module for short-range communication within a certain range. A short-range communication technology may include a wireless local area network (LAN), Wi-Fi, Bluetooth™, Zigbee™, Wi-Fi Direct (WFD), ultra-wideband (UWB), Infrared Data Association (IrDA), Bluetooth Low Energy (BLE), Near Field Communication (NFC), and the like but is not limited thereto.

The wired communication module 520 means a module for communication using an electrical signal or an optical signal. A wired communication technology may include a pair cable, a coaxial cable, an optical fiber cable, Ethernet cable, and the like but is not limited thereto.

The mobile communication module 530 may transmit and receive a wireless signal with at least one of a base station, an external terminal, and the server 550 over a mobile communication network. The wireless signal may include a variety of types of data according to transmission and reception of a voice call signal, a video call signal, or a text/multimedia message.

The user interface 120 may be provided on a front side of the body 1100 and may receive not only a control command such as input of power, start/stop of operation, and the like from the user but also an output level selection command for adjusting a strength of a magnetic field B generated by each of the heating coils L.

The output level is obtained by discretely dividing the strength of the magnetic field B generated by each of the heating coils L. Since the strength of the magnetic field B corresponds to intensity of a current applied to the heating coils L, the output level may be obtained by discretely dividing the intensity of the current applied to the heating coils L. The output level may be divided into a plurality of levels and may be divided into, for example, level 0 to level 10. In this case, the heating coils L may be set to generate a relatively great magnetic field B as the output level increases, that is, the output level becomes close to level 10 such that the cooking container Y may be quickly heated. Of course, depending on a selection of a designer, the heating coils L may be set to generate a smaller magnetic field B as the output level decreases.

Each level may be defined by dividing the intensity of the applied current into equidistant intervals. In other words, current differences between the levels may be equal. For example, it may be defined that level 0 of the applied current is 0 A, and each of differences between currents corresponding to level 1 to level 10 is 1.6 A. In this case, level 10 may be defined as 16 A. Of course, depending on a selection of a designer, each of current differences between the levels may be randomly defined. Also, according to an embodiment, current differences between levels may not be equal. For example, current differences between some of the levels may be greater than current differences between other levels. However, the present invention is not limited thereto.

The user interface 120 may include an input portion 128 capable of receiving a variety of control commands from the user and a display 129 for displaying an operation state of a cooking apparatus to the user or allowing the user to recognize an input button.

The input portion 128 may be implemented using a variety of input means such as a physical button, a touch button, a touch pad, a knob, a jogging shuttle, an operational stick, a track ball, a track pad, and the like.

The display 129 may be implemented using, for example, a liquid crystal display (LCD), a light emitting diode (LED), an organic LED (OLED), or the like.

Also, the user interface 120 may include a touch screen panel (TSP) in which the input portion 128 and the display 129 are integrally provided.

Hereinafter, structures and operations of first to third coil driving circuits 311, 312, and 313 which supply high-frequency power to the triple heating coil L will be described in detail.

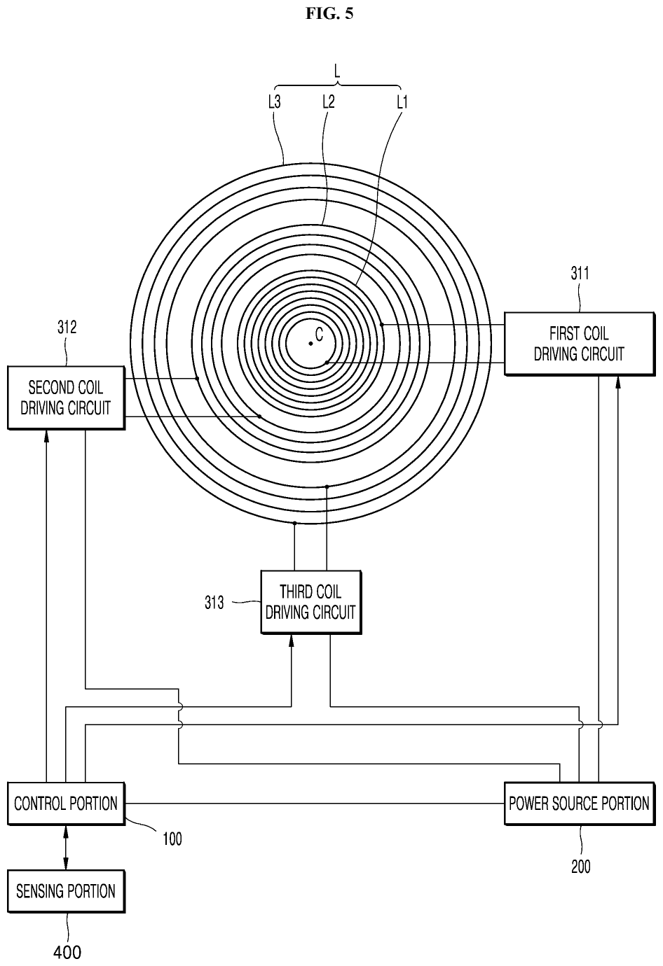

FIG. 5 is a block diagram of an induction heating cooker according to one embodiment of the present invention. For convenience of description, hereinafter, a repetitive description of the same content as described above will be omitted and differences will be mainly described.

Referring to FIG. 5, the induction heating cooker according to one embodiment of the present invention includes the heating coils L, the control portion 100, the power source portion 200, the first coil driving circuit 311, the second coil driving circuit 312, and the third coil driving circuit 313.

In detail, the heating coils L includes a first heating coil L1, a second heating coil L2, and a third heating coil L3. Here, the first heating coil L1 is disposed innermost, the second heating coil L2 is disposed outside the first heating coil L1, and the third heating coil L3 is disposed outside the second heating coil L2. That is, the first heating coil L1 may be disposed innermost, the second heating coil L2 may be disposed between the first heating coil L1 and the third heating coil L3, and the third heating coil L3 may be disposed outermost.

All the heating coils L1, L2, and L3 may have the same central point C and may be formed to have different diameters. The heating coils L1, L2, and L3 may be disposed to be spaced apart. The heating coils L1, L2, and L3 may have different numbers of coil turns. A detailed description thereof will be present below.

The heating coils L1, L2, and L3 may be controlled by the coil driving circuits 311, 312, and 313, respectively. For example, the first heating coil L1 is controlled by the first coil driving circuit 311, the second heating coil L2 is controlled by the second coil driving circuit 312, and the third heating coil L3 is controlled by the third coil driving circuit 313.

An operation of each of the heating coils L1, L2, and L3 is controlled by the control portion 100. Although not shown in detail, each of the coil driving circuits 311, 312, and 313 includes a switching portion, and an operation of the switching portion is controlled by a control signal received from the control portion 100.

Each of the coil driving circuits 311, 312, and 313 receives power from the power source portion 200. The power source portion 200 may provide the coil driving circuits 311, 312, and 313 with different phases of power or the same phase of power. For example, the power source portion 200 may provide the coil driving circuits 311, 312, and 313 with three types of power having different phases included in a three-phased power source. Also, the power source portion 200 may provide each of the coil driving circuits 311, 312, and 313 with single-phased power having the same phase. However, the present invention is not limited thereto.

The control portion 100 may control an operation of each of the coil driving circuits 311, 312, and 313. Also, the control portion 100 may selectively operate only some of the first to third coil driving circuits 311, 312, and 313. The control portion 100 may control an operation of the power source portion 200. The control portion 100 may control the power source portion 200 and the first to third coil driving circuits 311, 312, and 313 to operate the first to third heating coils L1, L2, and L3 with the same frequency.

The sensing portion 400 may measure a size of container disposed on the first to third heating coils L1, L2, and L3. The control portion 100 may selectively operate only some of the first to third coil driving circuits 311, 312, and 313 using data obtained through measuring by the sensing portion 400.

For example, when a container is disposed only on the first and second heating coils L1 and L2 and does not overlap with the third heating coil L3, the sensing portion 400 transmits such sensing information to the control portion 100. Sequentially, the control portion 100 may operate only the first and second heating coils L1 and L2 disposed below the container and may not operate the third heating coil L3. However, the present invention is not limited thereto.

That is, since the induction heating cooker according to the present invention senses a size of a container on the heating coils and operates only the coils located below the container, energy efficiency may be maximized by controlling an operation of an unnecessary coil and only a necessary heating coil may be operated automatically without an additional manipulation of a user so as to improve user convenience.

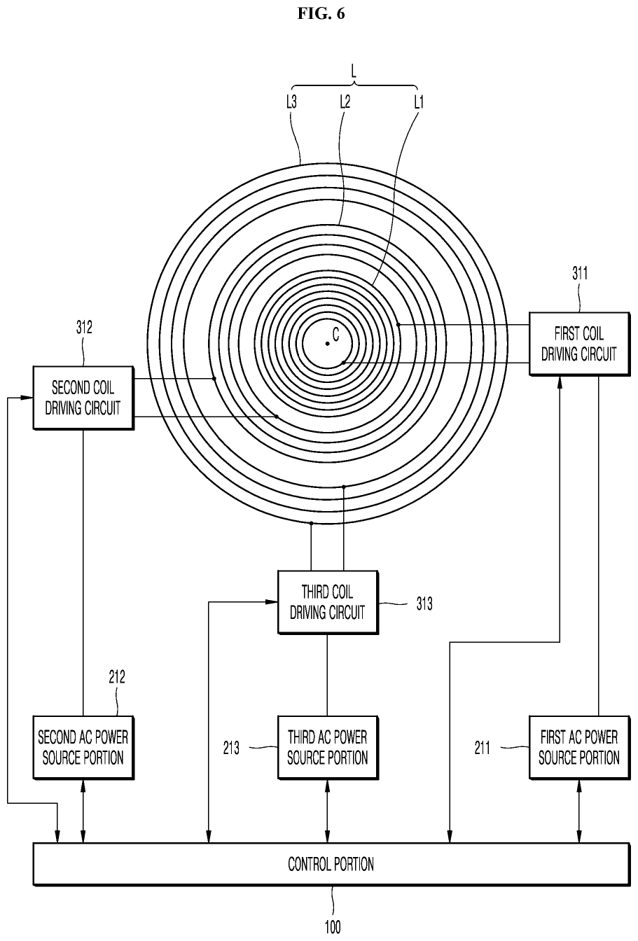

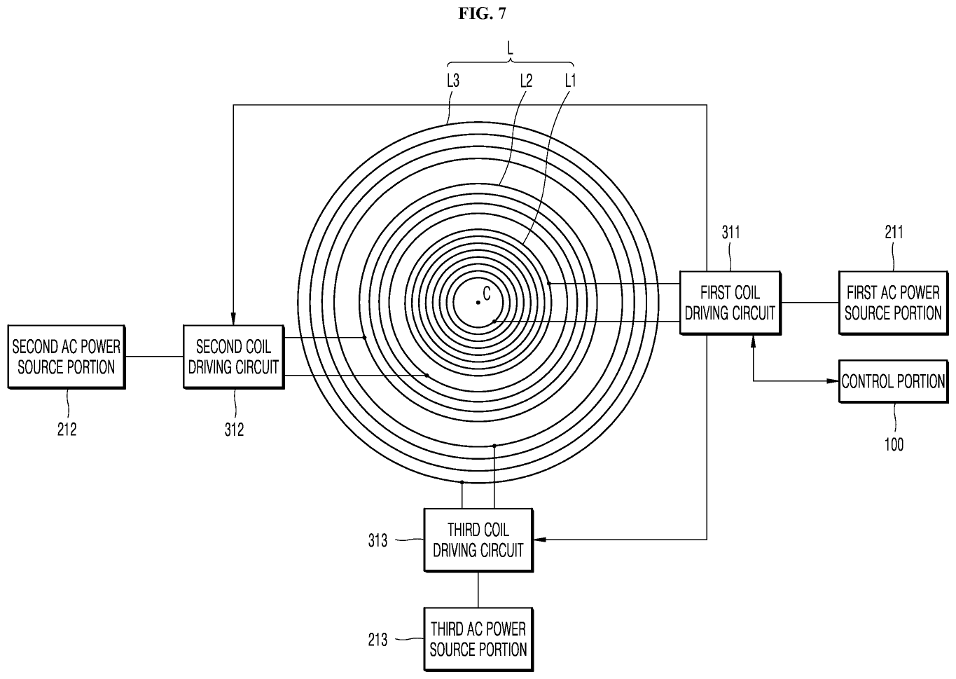

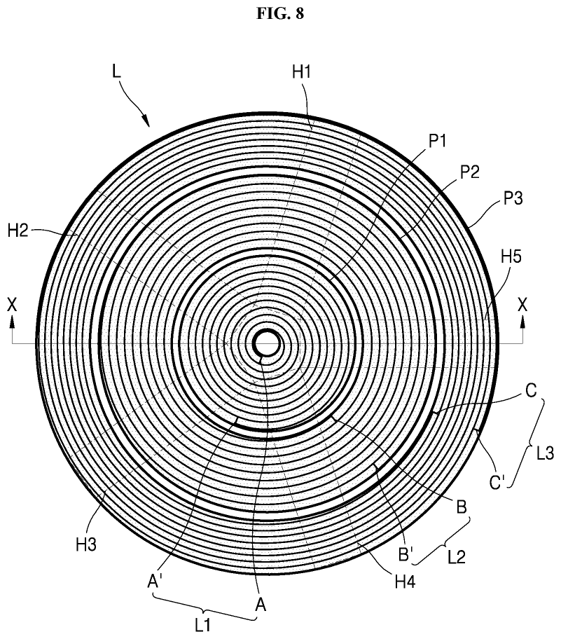

FIG. 6 is a block diagram of an induction heating cooker according to another embodiment of the present invention. FIG. 7 is a block diagram of an induction heating cooker according to still another embodiment of the present invention. For convenience of description, hereinafter, a repetitive description of the same items as described above will be omitted and differences will be mainly described.

Referring to FIG. 6, the induction heating cooker according to another embodiment of the present invention includes the heating coils L, the control portion 100, the first to third AC power source portions 211, 212, and 213, and the first to third coil driving circuits 311, 312, and 313.

The first to third AC power source portions 211, 212, and 213 correspond to different types of power sources. The first AC power source portion 211 provides the first coil driving circuit 311 with power, the second AC power source portion 212 provides the second coil driving circuit 312 with power, and the third AC power source portion 213 provides the third coil driving circuit 313 with power.

Here, the first to third AC power source portions 211, 212, and 213 may provide different-phased types of power. For example, the first AC power source portion 211 may provide R-phased AC power, the second AC power source portion 212 may provide S-phased AC power, and the third AC power source portion 213 may provide T-phased AC power.

However, the present invention is not limited thereto, and the first to third AC power source portions 211, 212, and 213 may provide single-phased power having the same phase.

Here, the first to third AC power source portions 211, 212, and 213 may provide the same power. For example, each of the first to third AC power source portions 211, 212, and 213 may provide power of about 3.7 kW at a place where a phase voltage is 230 V such that the first to third heating coils L1, L2, and L3 may provide power of about 10 kW or more. However, the present invention is not limited thereto.

Here, all the first to third AC power source portions 211, 212, and 213 may provide the same frequency power. The above may correspond to both a three-phased power source and a single-phased power source.

However, when a phase difference or a frequency change occurs in the same frequency, noise may occur while the induction heating cooker operates. To prevent this, the control portion 100 may control operations of the first to third coil driving circuits 311, 312, and 313 to synchronize operation frequencies and operation phases of power provided to the first to third heating coils L1, L2, and L3.

Referring to FIG. 7, the induction heating cooker according to still another embodiment of the present invention may have components substantially equal to those of the induction heating cooker described above with reference to FIG. 6. However, in the induction heating cooker of FIG. 7, the first coil driving circuit 311 may synchronize operation frequencies and operation phases of power to be provided to the first to third heating coils L1, L2, and L3.

That is, the first coil driving circuit 311 provides the second coil driving circuit 312 and the third coil driving circuit 313 with a signal for synchronizing operation frequencies. Through this, operation frequencies and operation phases of power to be provided to the first to third heating coils L1, L2, and L3 may be synchronized.

Substantially, the first coil driving circuit 311, which performs switching, performs synchronization such that synchronization performance may be improved and data and an operation quantity to be processed by the control portion 100 may be reduced. Here, the first coil driving circuit 311 has been described as an example, but the present invention is not limited thereto.

In conclusion, the heating coils including three coils, which have the same center and are spaced apart from each other, are used in the induction heating cooker according to the present invention such that maximum power of the induction heating cooker may be increased to 10 kW or more. Through this, since maximum power available in general home environments is provided, a time necessary for cooking may be reduced and needs of customers who want greater firepower may be satisfied.

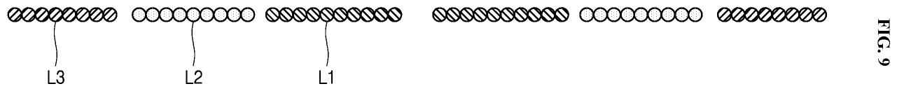

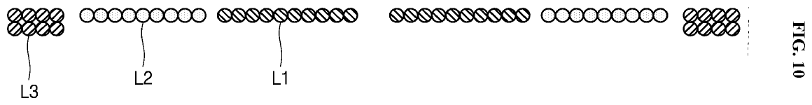

FIG. 8 is a view illustrating a triple heating coil included in an induction heating cooker according to some embodiments of the present invention. FIG. 9 is a cross-sectional view taken along line X-X of FIG. 8. FIG. 10 is a cross-sectional view illustrating a triple heating coil included in an induction heating cooker according to other embodiments of the present invention. For convenience of description, hereinafter, a repetitive description of the same content as described above will be omitted and differences will be mainly described.

Referring to FIGS. 8 and 9, the triple heating coil L included in the induction heating cooker according to some embodiments of the present invention may include the first heating coil L1, the second heating coil L2, and the third heating coil L3.

The heating coils may be supported by coil support portions P1, P2, and P3, respectively. In detail, the first heating coil L1 may be supported by a first coil support portion P1, the second heating coil L2 may be supported by a second coil support portion P2, and the third heating coil L3 may be supported by a third coil support portion P3. The coil support portions P1, P2, and P3 may be disposed to be spaced apart and to have the same center.

Magnetic member insertion portions H1 to H5 into which magnetic members are insertable may be formed below the coil support portions P1, P2, and P3. The magnetic member insertion portions H1 to H5 are circularly disposed at equidistant intervals in the drawing but this is merely an example and may be modified into a variety of embodiments.

The first to third heating coils L1, L2, and L3 may have the same central point and be formed to have different diameters. For example, an outer diameter of the first heating coil L1 may be 160 mm, an outer diameter of the second heating coil L2 may be 250 mm, and an outer diameter of the third heating coil L3 may be 270 to 300 mm. As described below in detail, a coil of the third heating coil L3 may be stacked as a single layer when the outer diameter is 270 mm and may be stacked as a plurality of layers when the diameter is 300 mm. However, this is merely an example, and the present invention is not limited thereto.

The first to third heating coils L1, L2, and L3 may be formed to have different numbers of turns. For example, a first coil included in the first heating coil L1 may have seventeen turns, a second coil included in the second heating coil L2 may have nine turns, and a third coil included in the third heating coil L3 may have eight turns. However, this is merely an example, and the present invention is not limited thereto.

Both ends A and A′ of the first coil included in the first heating coil L1 may be connected to the first AC power source portion 211, both ends B and B′ of the second coil included in the second heating coil L2 may be connected to the second AC power source portion 212, and both ends C and C′ of the third coil included in the third heating coil L3 may be connected to the third AC power source portion 213.

All of the first to third heating coils L1, L2, and L3 may be formed to have a single-layer structure. That is, all the first to third heating coils L1, L2, and L3 may be formed such that the coils are wound at the same height. All the first to third coils used in the first to third heating coils L1, L2, and L3 may include the same coils having the same thickness and may be formed to have a single layer. However, the present invention is not limited thereto.

Referring to FIG. 10, the first to third heating coils L1, L2, and L3 included in the triple heating coil L according to other embodiments of the present invention may be formed to have different heights.

For example, the first heating coil L1 and the second heating coil L2 may be formed as single layers at the same height, and the third heating coil L3 may be formed as two stacked layers. However, this is merely an example, and coils may be wound such that some or an entirety of the first to third heating coils L1, L2, and L3 are stacked as a plurality of layers.

Here, all the first to third heating coils L1, L2, and L3 may operate with the same frequency, may be provided with different phase types of power, or may be provided with single-phased power having the same phase.

That is, the triple heating coil formed of three coils receiving different types of power having three phases or a single phase is used in the induction heating cooker according to the present invention. Through this, the induction heating cooker of the present invention is operable in all power source environments which are different for each country such that versatility of products is increased. Also, each coil included in the induction heating cooker operates with the same operation frequency such that noise occurring in a plurality of coils operating with different frequencies may be eliminated and an output deviation of the plurality of coils caused by a phase deviation may be improved. Through this, quietness of the induction heating cooker may be improved and stability of output and operation of the induction heating cooker may be improved.

It should be noted that the above-described embodiments of the present invention are merely examples in all aspects and are not intended to be limitative and the scope of the present invention will be defined by the following claims rather than the above detailed description. Also, it should be interpreted that all modifications or modifiable shapes derived from the meaning and scope of the following claims and equivalents thereof are included in the scope of the present invention.

1. An induction heating cooker comprising:
a first heating coil;
a second heating coil provided radially outside of the first heating coil;
a third heating coil provided radially outside of the second heating coil;
a first coil driving circuit which applies a first type of power to the first heating coil;
a second coil driving circuit which applies a second type of power, which differs from the first type of power, to the second heating coil;
a third coil driving circuit which applies a third type of power, which differs from the first type of power and second type of power, to the third heating coil; and
a controller which manages the first coil driving circuit, the second coil driving circuit, and the third coil circuit such that the first heating coil, the second heating coil, and the third heating coil operate at a common frequency.

2. The induction heating cooker of claim 1, wherein the first type of power has a first phase,
wherein the second type of power has a second phase that is different from the first phase, and
wherein the third type of power has a third phase that is different from the first and second phases.

3. The induction heating cooker of claim 1, wherein the first type of power, the second type of power, and the third type of power have a common phase.

4. The induction heating cooker of claim 1, wherein the first heating coil, the second heat coil, and the third heating coil are concentric to have a same central point and respective different diameters.

5. The induction heating cooker of claim 1, wherein the first heating coil, the second heat coil, and the third heating coil are positioned to be spaced apart from each other.

6. The induction heating cooker of claim 1, wherein the first heating coil includes a first coil that is wound by a first number of turns,
wherein the second heating coil includes a second coil that is wound by a second number of turns, the second number of turns being different from the first number of turns, and
wherein the third heating coil includes a third coil that is wound by a third number of turns, the third number of turns being different from the first number of turns and the second number of turns.

7. The induction heating cooker of claim 6, wherein a thickness of the third coil corresponds to thicknesses of the first coil and the second coil, and the third coil includes plurality of layers that are stacked.

8. The induction heating cooker of claim 1, wherein an overall height of the third heating coil is different from an overall height of the first heating coil and an overall height of second heating coil.

9. The induction heating cooker of claim 1, further comprising a sensor which measures a size of a container positioned on the first heat coil, the second heat coil, and the third heating coil,
wherein the controller determines whether to selectively operate each of the first coil driving circuit, the second coil driving circuit, and the third coil driving circuit based on the size of the container.

10. An induction heating cooker comprising:
a first heating coil including a first coil wound by a first number of turns;
a second heating coil including a second coil wound by a second number of turns that is different from the first number of turns, the second heating coil being positioned radially outside the first heating coil;
a third heating coil including a third coil wound by a third number of turns that is different from the first number of turns and the second number of turns, the third heating coil being positioned radially outside the second heating coil;
a first alternating current (AC) power source configured to provide the first heating coil with a first type of power;
a second AC power source configured to provide the second heating coil with a second type of power that is different from the first type of power; and
a third AC power source configured to provide the third heating coil with a third type of power that is different from the first type of power and the second type of power,
wherein the first heating coil, the second heating coil, and the third heating coil are spaced apart from each other.

11. The induction heating cooker of claim 10, wherein the first AC power source provides first AC power having a first phase,
wherein the second AC power source provides second AC power having a second phase that is different from the first phase of the first AC power, and
wherein the third AC power source portion provides third AC power having a third phase that is different from the first phase of the first AC power and the second phase of the second AC power.

12. The induction heating cooker of claim 10, wherein each of the first AC power source, the second AC power source, and the third AC power source provides powers having common phase.

13. The induction heating cooker of claim 10, wherein the first heating coil, the second heating coil, and the third heating coil operate at a common operation frequency.

14. The induction heating cooker of claim 10, wherein the first heating coil, the second heating coil, and the third heating coil are concentric to have a common central point and different diameters.

15. The induction heating cooker of claim 10, wherein a thickness of the third coil corresponds to respective thicknesses of the first coil and the second coil, and the third coil includes a stacked plurality of layers.

16. The induction heating cooker of claim 10, wherein a thickness of the third coil corresponds to respective thicknesses of the first coil and the second coil and, the third coil includes a single layer.

17. The induction heating cooker of claim 10, further comprising:
a controller that manages the first AC power source, the second AC power source, and the third AC power source; and
a sensor that measures a size of a container positioned on the first heating coil, the second heating coil, and the third heating coil;
wherein the controller determines whether to selectively operate one or more of the first AC power source, the second AC power source, and the third AC power source based on the size of the container.

18. The induction heating cooker of claim 17, wherein the controller
operates the first AC power source and not the second AC power source or the third AC power source when the size of the container is less than or equal to an inner diameter of the second heating coil,
operates the first AC power source and the second AC power source but not the third AC power source when the size of the container is greater than the inner diameter of the second heating coil and is less than or equal to an inner diameter of the third heating coil, and
operates the first AC power source, the second AC power source, and the third AC power source when the size of the container is greater than the inner diameter of the third heating coil.

19. The induction heating cooker of claim 10, wherein each of the first AC power source, the second AC power source, and the third AC power source provides a common maximum power.

20. The induction heating cooker of claim 10, wherein the first AC power source, the second AC power source, and the third AC power source combine to output three-phase electrical power.
